(19) United States
(12) Patent Application Publication
(10) Pub. No.: US 2022/0152737 A1
(43) Pub. Date: May 19, 2022

(54) METHOD FOR LASER WELDING A COPPER/ALUMINIUM CONNECTION

(71) Applicant: TRUMPF Laser GmbH, Schramberg (DE)

(72) Inventor: Elke Kaiser, Aichhalden (DE)

(21) Appl. No.: 17/588,355

(22) Filed: Jan. 31, 2022

Related U.S. Application Data
(63) Continuation of application No. PCT/EP2020/071593, filed on Jul. 30, 2020.

(30) Foreign Application Priority Data
Aug. 1, 2019 (DE) 10 2019 211 581.0

(51) Int. Cl. B23K 26/244; B23K 26/323

(52) U.S. Cl. CPC B23K 26/244; B23K 2103/10; B23K 26/323

(57) ABSTRACT

A method for welding a copper/aluminum connection includes providing a first workpiece, which consists of a copper-containing material, in particular at least 80% by weight Cu, and a second workpiece, which consists of an aluminum-containing material, in particular at least 80% by weight Al, and welding the first workpiece and the second workpiece to one another in a surface region by means of a laser beam moved in relation to the first and second workpieces along a welding path. The laser beam is directed onto a surface of the first workpiece and the second workpiece is arranged behind the first workpiece with respect to the laser beam, with a greatest spot diameter SD of the laser beam on the surface of the first workpiece, where SD≤120 μm. The welding path is chosen such that the laser beam progressively penetrates into solid workpiece material along the welding path.

### CROSS REFERENCE TO RELATED APPLICATIONS

This application is a continuation of International Application No. PCT/EP2020/071593 (WO 2021/019052 A1), filed on Jul. 30, 2020, and claims benefit to German Patent Application No. DE 10 2019 211 581.0, filed on Aug. 1, 2019. The aforementioned applications are hereby incorporated by reference herein.

### FIELD

The invention relates to a method for welding a copper/aluminum connection.

### BACKGROUND

Such a method is disclosed by the conference paper by K. Mathivanan and P. Plapper, “Laser overlap joining from copper to aluminum and analysis of failure zone”, Lasers at the Manufacturing Conference 2019, Munich (DE), Jun. 24-27, 2019, Wissenschaftliche Gesellschaft für Lasertechnik e.V.

Connections with good electrical conductivity between components of copper and components of aluminum are required for the production of cell connectors of battery cells, for instance for electric vehicles. Such connections may be made for example by means of screwing, which however is time-consuming; what is more, the connection can come undone if it is subjected to vibrations such as often occur in vehicles.

In the conference paper by A. Haeusler et al., “Laser micro welding—a flexible and automatable joining technology for the challenge of electromobility”, Lasers at the Manufacturing Conference 2019, Munich (DE), Jun. 24-27, 2019, Wissenschaftliche Gesellschaft für Lasertechnik e.V., it is proposed to produce connections between components of copper and components of aluminum by laser welding.

However, connections between components of copper and components of aluminum obtained by laser welding are often quite brittle and already break under the effect of low external forces.

The aforementioned conference paper by K. Mathivanan and P. Plapper discloses a welding structure in which a component of copper arranged on top and a component of aluminum arranged thereunder are welded along a seam by a laser beam which is directed onto the component of copper from above. The laser beam has a diameter of 89 μm and is wobbled during the welding, wherein the laser beam performs along its welding path a series of loops in the form of figures of eight, which follow one another along the direction of the seam while mutually overlapping.

The wobbling can have the effect during the welding process of producing a melt pool that is much wider transversely to the direction of the seam than the melt pool occurring around the laser beam; the laser beam therefore keeps penetrating into liquid melt that has been created by itself when passing along a portion of the welding path already covered. Although, with this procedure, a comparatively great seam width can be produced by a thin laser beam, which improves the strength of the welding, even in this case the welding itself is quite brittle.

US 2017/0106470 A1 discloses welding two zinc-coated sheets along a spiral welding path by through-welding. This method is intended to avoid zinc-induced porosity, to reduce spatter and to bring about a smooth melt surface.

### SUMMARY

In an embodiment, the present invention provides a method for welding a copper/aluminum connection. The method includes providing a first, in particular upper, workpiece, which consists of a copper-containing material, in particular with at least 80% by weight Cu, and a second, in particular lower, workpiece, which consists of an aluminum-containing material, in particular with at least 80% by weight Al; and welding the first workpiece and the second workpiece to one another in a surface region by means of a laser beam moved in relation to the first and second workpieces along a welding path. The laser beam is directed onto a surface of the first workpiece, in particular from above, and the second workpiece is arranged behind the first workpiece, in particular under the first workpiece, with respect to the laser beam, with a greatest spot diameter SD of the laser beam on the surface of the first workpiece, where SD≤120 μm. The welding path is chosen, and the laser beam is moved along the welding path, such that the laser beam progressively penetrates into solid workpiece material along the welding path.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic cross section through a first workpiece and a second workpiece during a welding method according to the invention, perpendicularly to the feeding direction;

FIG. 2a schematically shows a meandering welding path for a method according to the invention, with a spacing between welding path portions alongside one another corresponding to a welded trace width;

FIG. 2b schematically shows a welded surface region which can be produced according to the invention with the welding path from FIG. 2a;

FIG. 3a schematically shows a meandering welding path for a method according to the invention, with a spacing between welding path portions alongside one another greater than a welded trace width;

FIG. 3b schematically shows a welded surface region which can be produced according to the invention with the welding path from FIG. 3a;

FIG. 4a schematically shows a welding path made up of straight, parallel, separate welding path portions for a method according to the invention, with a spacing between welding path portions alongside one another greater than a welded trace width;

FIG. 4b schematically shows a welded surface region made up of separate partial surface regions which can be produced according to the invention with the welding path from FIG. 4a;

FIG. 5 schematically shows a sequence for welding adjacently lying, here parallel, straight welding path portions of a welding path for the invention;

FIG. 6 schematically shows a welding path made up of a number of concentric, circular welding path portions for the invention;

FIG. 7 schematically shows a spiral welding path for the invention;

FIG. 8 schematically shows a welding path made up of straight, separate welding path portions parallel to one another for a first welding pass, for the invention; and

FIG. 9 schematically shows an overall welding path of two welding passes, wherein one of the welding passes uses the welding path from FIG. 8, and the other welding pass uses a welding path rotated by 40° with respect to FIG. 8, for the invention.

### DETAILED DESCRIPTION

Embodiments of the present invention provide a method for welding a copper/aluminum connection, wherein a first, in particular upper, workpiece, which consists of a copper-containing material, in particular with at least 80% by weight Cu, and a second, in particular lower, workpiece, which consists of an aluminum-containing material, in particular with at least 80% by weight Al, are welded by means of a laser beam, wherein the laser beam is directed onto a surface of the first workpiece, in particular from above, and the second workpiece is arranged behind the first workpiece, in particular under the first workpiece, with respect to the laser beam, with a greatest spot diameter SD of the laser beam on the surface of the first workpiece, where SD≤120 μm, and wherein the laser beam is moved in relation to the workpieces along a welding path and, as a result, the workpieces are welded to one another in a surface region.

Embodiments of the present invention provide less brittle welding for a copper/aluminium connection. Exemplary embodiments provide a method of the type mentioned at the beginning, which is characterized in that the welding path is chosen, and the laser beam is moved along the welding path, such that the laser beam progressively penetrates into solid workpiece material along the welding path.

It has been found with embodiments of the invention that weldings between the first workpiece of a copper-containing material and the second workpiece of an aluminum-containing material with very low brittleness can be obtained by the method according to embodiments of the invention. The surface region welded according to embodiments has a high mechanical strength, and can reliably ensure good electrical contact between the first and the second workpiece, as is desired in the case of applications for connecting battery cells.

When welding copper and aluminum, intercrystalline phases that make the welding brittle can occur in the cooled-down melt, which contains copper and aluminum.

With the method according to embodiments of the invention it is possible to keep down the proportion of aluminum in the melt, whereby the formation of the brittleness-increasing intercrystalline phases is reduced. As a result, the welded surface region thereby becomes mechanically particularly strong and robust.

During the welding, the energy of the laser beam is used for heating and melting workpiece material and creating a vapor cavity.

As far as the melting of workpiece material is concerned, in the invention the energy of the laser beam is used for the most part for melting the copper over the full thickness of the first workpiece, and a smaller part of the laser energy is used for melting aluminum of the second workpiece. To obtain strong welding, it is enough just to melt the second workpiece over a small welding-in depth, in particular much less (for example 50% or less or else 30% or less or else 20% or less) than the thickness of the first workpiece and than the thickness of the second workpiece. Corresponding to the small welding-in depth in the second workpiece, only little aluminum material is introduced into the melt. The fact that the laser beam keeps having to penetrate into solid workpiece material on its welding path means that this ratio of depths of the first workpiece (or the Cu-containing material) and the second workpiece (or the Al-containing material) that are melted by the energy of the laser beam is maintained, and the composition of the melt pool can be kept favorably on the side of the copper in the Cu—Al phase diagram, so that only a small proportion of intercrystalline phases occurs in the welded surface region.

If, on the other hand, the laser beam were to penetrate into already existing liquid melt along its melting path, created when it is passing along a previous portion of the welding path, no energy for heating and melting solid copper would have to be expended in this region, and the laser beam would additionally melt solid aluminum and introduce it into the melt in an undesired way. Exemplary embodiments of the invention can avoid this by the intended course of the melting path (and the performance of the movement of the laser beam along the welding path). According to exemplary embodiments of the invention, the laser beam does not penetrate into a liquid melt pool that has been previously created by the laser beam when passing along a portion of the welding path already covered. Preferably, the laser beam also does not penetrate into a still highly preheated region of the workpiece (for example preheated to 80% of the melting temperature in K or more, or to 220° C. or more), which has previously been melted or greatly heated by the laser beam when passing along a welding path portion already covered.

In embodiments of the invention, a comparatively small spot diameter of the laser beam on the surface of the first workpiece and a high brilliance of the laser beam are used, in order to achieve high temperature gradients in the workpiece. As a result, the melting processes are confined to a narrow space, which helps to keep down the introduction of aluminum into the melt. The (greatest) spot diameter SD of the laser beam on the surface of the first workpiece is typically SD≤100 μm, preferably SD≤65 μm, particularly preferably SD≤50 μm. The laser beam also typically has a beam parameter product SPP of <2.2 mm*mrad, preferably <0.4 mm*mrad.

It should be noted that, in embodiments of the invention, usually a comparatively high feed rate is chosen for the laser beam; this likewise contributes to restricting melting of aluminum, and to keeping down the proportion of aluminum in the melt. Typical feed rates of the laser spot on the workpiece (“geometrical rate”) in the case of typical laser power outputs (around 0.3-0.8 kW) and thicknesses (each around 0.2-0.4 mm) of the two workpieces are in the range of 400 mm/s and more, often of 600 mm/s and more. In order to achieve a correspondingly great feed rate, the laser beam is typically guided through a scanner, preferably comprising a piezo-controlled mirror.

The welding path may be contiguous or else made up of separate segments. The welded surface region may preferably be contiguous or else made up of a number of separate partial surface regions. Typically, the surface region that is produced by means of the welding path has altogether a smallest outer diameter KAD, where KAD≥3*SB, preferably KAD≥20*SB, with SB: the local width (“trace width”) of a welded partial surface region created by a welding path portion with the laser beam. In other words, the welded surface region as a whole is in each direction at least three times as great, preferably at least 8 times as great, particularly preferably at least 20 times as great, as the trace width SB. It should be noted that, in the invention, typically: SB≤150 μm, preferably SB≤100 μm.

The absolute strength of the welded surface region may be set almost however desired over the length of the welding path that is welded altogether (as long as the workpieces are large enough); in this case, a zone intended for the welding may be passed over with the welding path as a pattern, for example covered with a “hatching” or with meanders.

The welding method according to embodiments of the invention is generally performed as deep penetration welding, in order to achieve good coupling of the energy of the laser beam into the copper material facing the laser beam. In this case, solid-state lasers or fiber lasers with a wavelength in the infrared (for example with a wavelength of between 1000 nm and 1100 nm) can be used with low cost.

A particularly preferred variant of the method according to embodiments of the invention is in which the welding path is crossing-free. This makes it easier to carry out the process and generally allows a fast feed rate. If there were crossings in the welding path, it would have to be ensured by sufficient cooling times or by carrying out the process sufficiently slowly that the portion of the welding path previously passed by the laser beam has already cooled down to a sufficient extent when it is passed again that the material of the workpiece has already solidified again there (over the full thickness of both workpieces), and best of all has also substantially cooled down again. When crossing-free welding paths are chosen, it is quite possible to avoid passing over an already previously created liquid melt pool with the laser beam in the case of typical sizes of welded surface regions, for instance with a smallest outside diameter KAD of 2 mm or more.

Another particularly preferred variant of the method according to embodiments of the invention provides that the method comprises at least two, preferably precisely two, successive welding passes, wherein, in the various welding passes, welded pass surface regions of the workpieces overlap at least partially, preferably by at least 50%, particularly preferably by at least 80%, and that, within each welding pass, the welding path is crossing-free. Welding a number of times in the overlapping pass surface regions allows the strength of the welding to be increased. The absence of crossing of the welding path within the passes in turn allows the process to be carried out more easily and quickly.

Advantageous in this respect is a further development of this variant in which the welding paths of the various welding passes correspond to one another. In other words, the welding path of the second welding pass represents a repetition of the welding path of the first welding pass. As a result, the same surface region can be specifically welded again in order to improve the strength.

In the case of another advantageous further development, the welding paths of the various welding passes are rotated with respect to one another by an angle α, in particular where 30°≤α≤150°, preferably α=60° or α=90°. As a result, in particular in the case of hatching-like patterns of the welding path, a grid structure or network of the welded pass surface regions can be achieved, whereby particularly high strengths are made possible. In particular in the case of patterns of the welding path based on spirals or concentric circles, a displacement of the otherwise mutually corresponding welding paths of the various passes can alternatively or additionally also be used.

A further, advantageous development of the above embodiment provides that the welding path is chosen, and the laser beam is moved along the welding path, such that a preheating from a respective previous welding pass has subsided to such an extent that a maximum welding-in depth MT into the second workpiece in a subsequent welding pass is at most 10% greater than in the previous welding pass, preferably at most just the same magnitude as in the previous pass. This achieves the effect that the increase in strength provided by the double welding is not noticeably sacrificed again by a shift in the composition in the Cu—Al phase diagram toward the Al (and correspondingly greater brittleness).

In the case of an advantageous variant, the welding path comprises a multiplicity of welding path portions, which lie adjacent to one another in a direction transverse to the local direction of extent of the welding path.

Typically, at least three or at least five or at least seven or at least twelve adjacently lying welding path portions are set up. As a result, larger surface regions or zones on the workpieces can be made available for welding by means of using the method according to the invention, and the strength of the welded connection of the workpieces can be specifically improved with regard to expected directions of loading or types of loading.

Particularly preferred is a further development of this variant in which the adjacently lying welding path portions, in particular their spacing AB in the direction transverse to the local direction of extent, are chosen such that welded partial surface regions that occur along the respective adjacently lying welding path portions directly adjoin or overlap one another. In other words, AB≤SB (with SB: the trace width of the welding). As a result, an available zone can be optimally used for welding, and particularly good strengths are achieved over a small surface area.

It is alternatively provided in another further development that the adjacently lying welding path portions, in particular their spacing AB in the direction transverse to the local direction of extent, are chosen such that welded partial surface regions that occur along the respective adjacently lying welding path portions remain separated by unwelded intermediate regions. In other words, AB>SB (with SB: the trace width of the welding).

Typically, in this case SB<AB≤4*SB is chosen. As a result, the welded surface region can be distributed over a larger zone of the workpieces, which can produce better mechanical strength in use in the case of some types of loading of the workpieces.

Also preferred is a further development of exemplary embodiments of the invention in which, after welding one welding path portion, first a welding path portion that is further away is welded before a welding path portion alongside is welded.

In other words, between the welding of two welding path portions that are alongside one another (in the direction transverse to the direction of extent of the welding path), first at least one other welding path portion that is not alongside either of the two first welding path portions (in the direction transverse to the direction of extent of the welding path) is interposed; preferably, the length LA of the other welding path portion that is further away is at least equal to three times the spacing AB between the two welding path portions that are alongside one another (in the direction transverse to the direction of extent of the welding path). As a result, a minimum cooling time after the welding of a welding path portion is ensured, so that any propagation of heat into the welding path portion alongside has already noticeably cooled down again when this portion is welded. This prevents or reduces unintentional introduction of aluminum into the melt.

Also preferred is a variant in which the surface region is formed as a welding point. Welding points can achieve high strength, and in particular good electrical contact, in a small space; moreover, they are comparatively easy and quick to produce (in comparison with elongated weld seams). The welding point is typically outwardly surrounded on all sides (over its entire circumference) by unwelded workpiece material.

Typically, the welding point has an aspect ratio (ratio of the long side to the short side in the case of rectangular welded surface regions, or ratio of the greatest diameter to the diameter perpendicular thereto in the case of other welded surface regions) of 3 or less, usually 2 or less, and often of 1. The welding point is typically formed as circular on the outside, but can also be formed as angular, in particular square or rectangular, or else irregular. The welding point may contain an unwelded inner region inside it. To strengthen the connection of the two workpieces, a number of welding points may be set adjacent to one another.

Advantageous is a variant in which the surface region is formed as annular, in particular circular-annular. Annular weldings can be produced well by the invention, and in particular in the case of vibrational loadings, which may be accompanied by surges of force in different directions, are particularly robust.

Another preferred variant is in which the welding path is at least partially spiral, in particular in the form of an Archimedes spiral. The spiral form makes it possible to make a large welded surface region accessible with a continuous welding path. The laser beam does not need to be switched off or obscured, and the scanner does not have any unused inactive times for repositioning the laser beam.

Also preferred is a variant in which the welding path comprises a number of concentric, circular welding path portions. With these, very great, isotropic strengths can be achieved.

Also advantageous is a variant in which the welding path comprises a number of straight-extending welding path portions lying parallel to one another. Such a welding path is particularly easy to program. Usually, with it a zone on the workpieces to be welded is hatched. The straight welding path portions lying parallel to one another may be separate segments of the welding path, or else be connected to one another in the welding path in a meandering manner.

Another particularly preferred embodiment is a variant which provides that the welding of the workpieces is performed as welding in, wherein the second workpiece is only melted as far as a maximum welding-in depth MT, where

MT≤0.5*D2,

preferably MT≤0.3*D2,

particularly preferably MT≤0.2*D2,

with D2: the thickness of the second workpiece.

Embodiments of the invention allow small welding-in depths to be reliably realized, so that only little aluminum material gets into the melt and the welded surface region has a low brittleness and high strength, in particular tensile strength.

Another preferred variant provides that the laser beam is generated by a cw laser, and/or that the laser beam has a wavelength λ in the infrared spectral range, in particular where 1000 nm≤λ≤1100 nm. With a cw laser, the energy input into the workpieces can be controlled better, and it can be reliably achieved that a smaller amount of aluminum is introduced into the melt. In the infrared range, lasers with high brilliance are commercially available at low cost and have been successfully used in practice with the method according to embodiments of the invention.

Another particularly preferred variant provides

that the first workpiece has a thickness D1 where 0.2 mm≤D1≤0.4 mm, in particular 0.25 mm≤D1≤0.35 mm,

that the second workpiece has a thickness D2 where

0.2 mm≤D2≤0.4 mm, in particular 0.25 mm≤D2≤0.35 mm,

that the laser beam has a power output P where

300 W≤P≤800 W, in particular 400 W≤P≤600 W,

that the laser beam has a spot diameter SD on the surface of the first workpiece where

25 μm≤SD≤65 μm, in particular 30 μm≤SD≤50 μm,

and that the laser beam has a relative feed rate V to the workpieces, where

400 mm/s≤V≤1000 mm/s, in particular 600 mm/s≤V≤850 mm/s. With these parameters, copper/aluminum weldings with a high tensile force and a high peel force can be produced.

Also preferred is a variant in which the laser beam has a focus position that is defocused with respect to the workpiece surface of the first workpiece, in particular with a defocusing DF where 0.3 mm≤DF≤0.7 mm or −0.3 mm≤DF≤−0.7 mm. In this way, a spiking of the welded surface can be avoided, and a uniform welding-in depth can be achieved.

Also preferred is a variant in which the welding is performed under an argon atmosphere. By using argon as a shielding gas, it has been possible to achieve a considerable reduction of welding spatter, and for the overall quality of the welded surface to be improved.

The present invention also includes the use of the method according to the invention for producing electrical contacts on battery cells.

The battery cells may be used in particular in electric vehicles. The high strength and reliability of an electrical connection at the welded surface region is particularly useful for the battery cells produced.

Further advantages of the invention are evident from the description and the drawing. Likewise, the features mentioned above and those to be explained still further can be used according to the invention in each case on their own or together in any combination. The embodiments shown and described should not be understood as an exhaustive list, but rather are of exemplary character for outlining the invention.

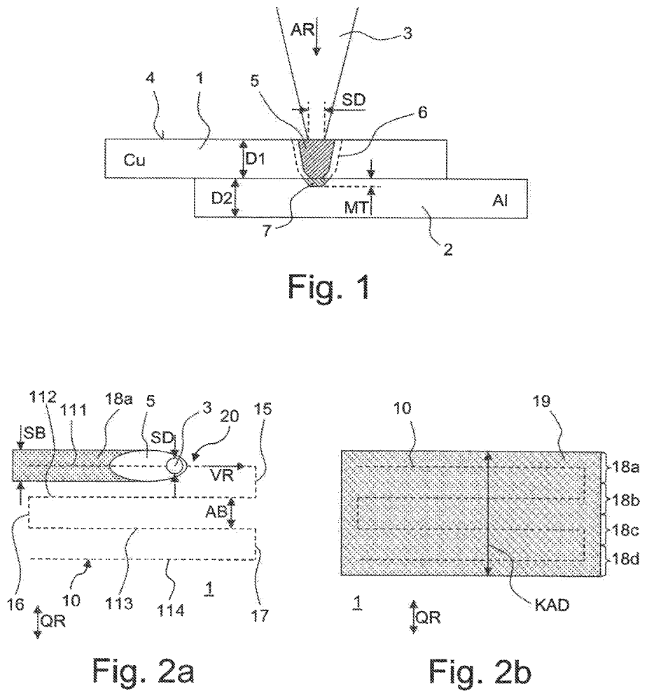

FIG. 1 schematically illustrates the welding of a copper/aluminum connection according to one exemplary variant of the method according to the invention.

A first, upper workpiece 1 of a Cu-containing material, for instance metallic copper, is to be welded onto a second, lower workpiece 2 of an Al-containing material, for instance metallic aluminum. For this purpose, the two workpieces 1, 2 are placed overlapping on one another, and in the overlapping region are irradiated with a laser beam 3.

The laser beam 3 in this case irradiates a surface 4 of the first workpiece 1, here from above, and the second workpiece 2 is arranged behind the first workpiece 1, here below, with respect to the direction of propagation AR of the laser beam 3.

During the welding operation, the laser beam 3 is fed along a welding path in a feeding direction; the (local) feeding direction here lies perpendicularly to the plane of the drawing of FIG. 1.

On the workpiece surface 4, the laser beam 3 has a spot diameter SD. The focus of the laser beam 3 lies slightly above or (here) below the workpiece surface (defocusing).

The laser beam 3 melts the first workpiece 1 over its full thickness D1, cf. the melt 5, which can create a vapor cavity by the laser beam 3. It should be noted that the Cu-containing material melts at approximately 1100° C.

On the one hand, heat propagates into the surroundings of the melt 5 in the first workpiece 1, cf. the isotherms 6, at approximately 700° C.

On the other hand, heat also propagates into the subjacent second workpiece 2.

The Al-containing material of the second workpiece 2 melts at a temperature of approximately 700° C., and a melt 7 also forms in the second workpiece 2. This reaches into the second workpiece as far as a maximum welding-in depth MT.

In the illustrated variant, approximately MT=0.2*D2.

It should be noted that the melts 5 and 7 mix during the welding. As a result of the only small proportion of Al in the mixed melt (referred to hereinafter for the sake of simplicity as melt 5), with the invention a welding of only low brittleness and high strength can be achieved after the solidifying of the melt.

FIG. 2a illustrates a welding path 10 (shown by dashed lines), along which in one variant of the invention the laser beam 3 can be guided on the surface of the first workpiece 1.

The welding path 10 is formed here in a meandering manner, and has here four welding path portions 111, 112, 113, 114 lying adjacent to one another in a direction QR transverse to the local direction of extent VR (which corresponds to the feeding direction) and lying parallel to one another. The adjacently lying welding path portions 111-114 are connected to one another here by further welding path portions 15-17, extending in the direction QR, to form a contiguous welding path 10. The welding path portions 111-114 alongside one another in the direction QR are at a mutual spacing AB in the direction QR.

The laser beam 3 advancing along the direction of extent VR in relation to the first workpiece 1 creates a melt (melt pool) 5 around it and especially behind it; this melt 5 solidifies at its rear end and forms behind it a welded partial surface region 18a. The laser beam leaves as it were a welded “trace”.

The width of the partial surface region 18a in the direction QR is SB, also known as the “trace width”.

The trace width SB is much greater than the spot diameter SD, here with approximately SB=2*SD.

The welding path 10 and the welding parameters are chosen such that, as it advances on the workpiece 1, the laser beam 3 is always working its way into solid workpiece material 20, which lies in front of it in the direction of extent VR of the welding path 10, and in particular never penetrates into the liquid melt 5, which it draws behind itself (as is the case when wobbling in order to widen the weld seam). For this purpose, the welding path 10 is preferably formed without any crossing. Moreover, the welding path 10 preferably has within a respective continuous feed section corresponding to the trace width SB changes in direction of a maximum of 90° with respect to the previous direction of extent VR.

In the variant shown, the welding parameters and the welding path 10 are chosen such that the trace width SB is equal to the spacing AB.

This achieves the effect that the welded partial surface regions 18a-18d, which originate from the welding path portions 111-114 alongside one another in the direction QR, are combined to form a contiguous, continuous, uninterruptedly welded surface region 19, cf.

FIG. 2b, in particular without unwelded intermediate regions between the partial surface regions 18a-18d. The welded surface region 19 forms here a rectangular welding point, with an aspect ratio (long side to short side) of approximately 2.

In the variant shown, the smallest outside diameter KAD of the surface region 19 that is welded altogether is approximately 4 times as great as the trace width SB.

It should be noted that the same contiguous, welded surface region 19 would be obtained if the further welding path portions 15-17 were omitted in the welding path 10, that is to say the welding path 10 were to consist only of the separate welding path portions 111-114.

The welding path 10 shown in FIG. 2a, 2b may serve on its own for welding a first and a second workpiece, or be used twice in successive welding passes, with the same welding path 10 being passed over twice in succession.

Preferably, the two welding passes are in this case passed along in an identical direction, so that, at the location of the welding beam 3 in the second pass, the workpiece material has previously in each case been able to solidify and cool down completely without any problem, so that the welding-in depths in the two passes are virtually the same.

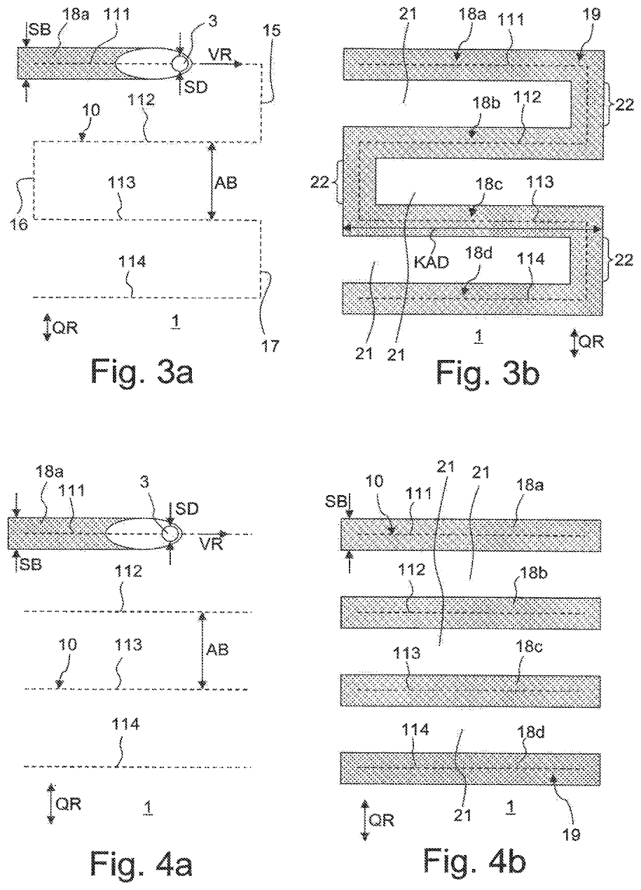

The variant of a welding path 10 for the invention that is shown in FIG. 3a is similar to the variant from FIG. 2a-2b, so that only the essential differences are explained.

In the variant shown, the spacing AB between the welding path portions 111-114 of the welding path 10 that are alongside one another in the direction QR is set up as much greater than the trace width SB, here with approximately AB=2.5*SB.

As a result, unwelded intermediate regions 21 remain in each case between the welded partial surface regions 18a-18d in the direction QR, cf. FIG. 3b.

Since the workpieces are also welded, and corresponding welded partial surface regions 22 are created, in the further welding path portions 15-17, also in this variant the welded surface region 19 is contiguous, but has gaps at the intermediate regions 21.

In the variant shown, the smallest outside diameter KAD of the surface region 19 that is welded altogether is approximately 8 times as great as the trace width SB.

The welded surface region 19 forms a welding point with an aspect ratio of the welded surface region of approximately 1.1.

The variant of a welding path 10 for the invention that is shown in FIG. 4a is similar to the variant from FIG. 3a-3b, so that only the essential differences are explained.

In the case of this variant, the welding path 10 only consists of the welding path portions 111-114 alongside one another in the direction QR transverse to the (local) direction of extent VR.

On account of the spacing AB, which is approximately 2.5 times as great as the trace width SB, an unwelded intermediate region 21 remains in each case between the welded partial surface regions 18a-18d, and the welded partial surface regions 18a-18d are separate from one another.

The welded surface region 19 consists of four non-contiguous partial surface regions 18a-18d, with gaps lying in between.

The welding point formed by the (multi-piece) welded surface region 19 has in turn an aspect ratio of approximately 1.1.

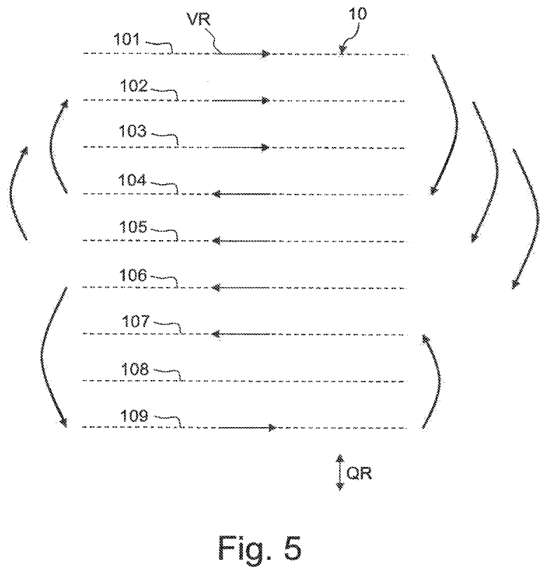

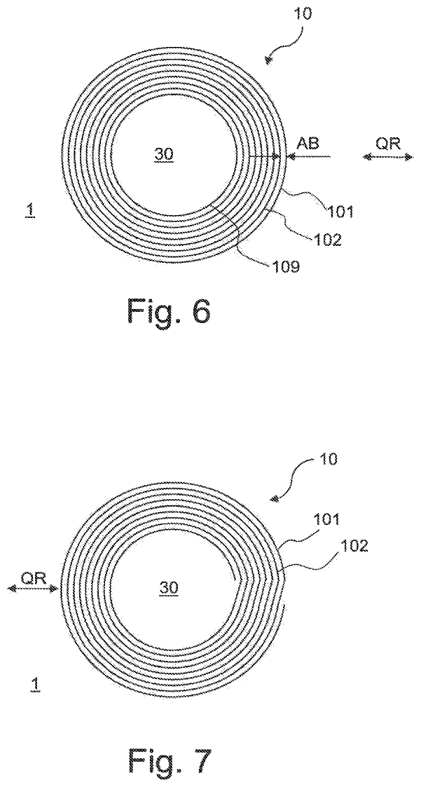

In exemplary embodiments of the invention, the welding path usually has in practice a great number of welding path portions lying adjacent to one another, for example more than eight adjacently lying welding path portions. Especially in the case of a small spacing AB and great feed rates, there is the risk of a welding-in depth being unintentionally increased when welding path portions alongside one another are welded immediately after one another in time due to the introduction of heat from the welding path portion alongside. This can be avoided by providing that, between welding path portions that are (directly) alongside one another, first one or more other welding path portions that are not (directly) alongside are welded, as explained by way of example below in FIG. 5.

The welding path 10 consists here of a multiplicity of welding path portions 101-109 arranged alongside one another in the direction QR transverse to the local direction of extent VR. Here, the welding path portions 101-109 are straight and parallel to one another and also of the same length; however, it is also possible that the welding path portions are curved and/or are of different lengths.

According to the process sequence provided here, first the welding path portion 101 is welded from left to right. Then, the laser scanner jumps (over the welding path portions 102 and 103) to the welding path portion 104, which is welded from right to left. Next, the laser scanner jumps back (over the welding path portion 103) to the welding path portion 102, which is welded from left to right. There then follows a jump to the welding path portion 105 (over the welding path portions 103 and 104), which is welded from right to left. After that, the laser scanner jumps back to the welding path portion 103 (that is to say over the welding path portion 104), which is welded from left to right. Finally, the laser scanner jumps to the welding path portion 106 (that is to say over the welding path portions 104 and 105), which is welded from right to left.

The welding of further welding path portions 107-109 and so on can be continued as long as desired according to this scheme. Jumps forward by three welding path portions alternate in each case with jumps back by two welding path portions. If desired, other jumping patterns, in particular with greater jumps, may also be used. However, each individual jump should go forward or back over at least two welding path portions, in order to avoid immediately successive welding of welding path portions alongside one another.

FIG. 6 shows a preferred welding path 10 (also known as a welding pattern) for exemplary embodiments of the invention, consisting here of nine concentric, circular welding path portions; by way of example, the outermost welding path portion 101, the second-outermost welding path portion 102 and the innermost welding path portion 109 are denoted more specifically.

Preferably, the spacing AB between the welding path portions 101, 102, 109 in the direction QR transverse to the local direction of extent of the welding path 10 is chosen to be equal to (or less than) the trace width, so that an uninterrupted, annular, welded surface region is obtained by the welding along the welding path 10. The smallest outside diameter KAD of the welded surface region (which here is the diameter of the outermost circular welding path portion 101 plus a trace width SB) is then approximately 40 times as great as the trace width SB.

In the inner region 30 within the innermost welding path portion 109, no further welding path portions are provided, in order not to make the interior of the welding point too hot, and to prevent through-welding there (that is to say melting of the second workpiece as far as its rear side facing away from the laser beam).

It should be noted that the circular melting path portions 101, 102, 109 can in principle be welded in any desired sequence. By welding in series, preferably from the inside to the outside (or alternatively from the outside to the inside), a particularly high production rate can be achieved. Alternatively, it is also possible by suitable jumps to avoid the welding of welding path portions 101, 102, 109 alongside one another immediately in succession one after the other (cf. FIG. 5 above by analogy).

With the welding path from FIG. 6, a welding point with an aspect ratio of 1 can be obtained.

In experiments comprising welding Cu and Al sheets each with a thickness of 3 mm, with a welding point welded according to the welding path 10 from FIG. 6 and a diameter of the outermost welding path portion 101 of approximately 3.2 mm, it was possible to achieve a tensile strength of approximately 250 N and a peel strength of approximately 50 N.

FIG. 7 shows a welding path 10 for an exemplary embodiments of the invention similar to that shown in FIG. 6; only the essential differences are explained.

The welding path 10 is formed here as a continuous spiral. The individual turns of the spiral may be understood as respectively a welding path portion; by way of example, the radially outermost and second-outermost turns are marked as welding path portions 101, 102. The turns or welding path portions 101, 102 follow one another in the direction QR transverse to the (local) direction of extent of the welding path 10. The spiral can be welded particularly quickly and easily.

With the welding path from FIG. 7, a welding point with an aspect ratio of 1 can be obtained.

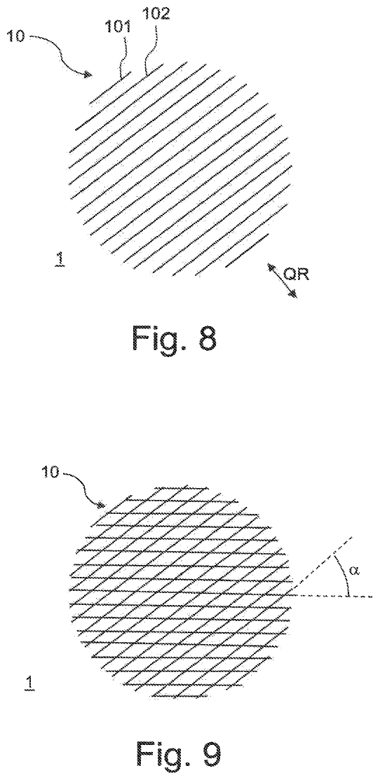

FIG. 8 shows a welding path 10 for the invention, which in turn consists of separate, straight welding path portions that are parallel to one another; by way of example, the welding path portions 101 and 102 are marked. The welding path portions 101, 102 are arranged alongside one another and following one another in the direction QR. The welding path 10 from FIG. 8 covers an approximately circular zone of the workpiece 1 in the manner of a hatching.

Typically, the welding path from FIG. 8 is used for a first welding pass, and is combined with a subsequent second welding pass, in which the welding path from FIG. 8, rotated here by approximately α=40°, is used in the same circular zone. This then produces the (overall) welding path 10 or the welding pattern from FIG. 9.

Within each welding pass, the welding path 10 is crossing-free. Enough time passes between the welding passes for the previous heating of the first pass to no longer have any noticeable influence in the second pass on the welding-in depth in the second workpiece, that is to say the welding-in depths in the two passes are approximately the same.

The partial surface regions welded in the respective welding pass overlap at least to a considerable extent, whereby particularly strong welding is achieved.

The rotation allows a contiguous welded surface region to be obtained overall, even whenever the welded partial surface regions of the welding path portions 101, 102 from one pass are not contiguous or abutting.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 First workpiece (Cu-containing)

2 Second workpiece (Al-containing)

3 Laser beam

4 Surface of the first workpiece

5 Melt (melt pool) (first workpiece)

6 Isotherms 700° C.

7 Melt (second workpiece)

10 Welding path

15-17 Further welding path portion

18a-18d Welded partial surface region

19 Welded surface region

20 Solid workpiece material

21 Unwelded intermediate region

22 Welded partial surface region

30 Inner region

101-114 Welding path portions alongside one another in direction QR

AB Spacing

AR Direction of propagation (laser beam)

D1 Thickness of first workpiece

D2 Thickness of second workpiece

KAD Smallest outside diameter

MT Maximum welding-in depth

QR Direction transverse to direction of extent/feeding direction

SB Trace width

SD Spot diameter (laser beam)

VR Direction of extent/feeding direction

α Angle

What is claimed is:

1. A method for welding a copper/aluminum connection, comprising:
providing a first, in particular upper, workpiece, which consists of a copper-containing material, in particular with at least 80% by weight Cu, and a second, in particular lower, workpiece, which consists of an aluminum-containing material, in particular with at least 80% by weight Al; and
welding the first workpiece and the second workpiece to one another in a surface region by means of a laser beam moved in relation to the first and second workpieces along a welding path,
wherein the laser beam is directed onto a surface of the first workpiece, in particular from above, and the second workpiece is arranged behind the first workpiece, in particular under the first workpiece, with respect to the laser beam, with a greatest spot diameter SD of the laser beam on the surface of the first workpiece, where SD≤120 μm, and
wherein the welding path is chosen, and the laser beam is moved along the welding path, such that the laser beam progressively penetrates into solid workpiece material along the welding path.

2. The method as claimed in claim 1, wherein the welding path is crossing-free.

3. The method as claimed in claim 1, wherein the method comprises at least two successive welding passes, wherein, in the at least two successive welding passes, at least two welded pass surface regions of the first and second workpieces overlap at least partially, and that, within each of the at least two successive welding passes, the welding path is crossing-free.

4. The method as claimed in claim 3, wherein the welding paths of the at least two successive welding passes correspond to one another.

5. The method as claimed in claim 3, wherein the welding paths of the at least two successive welding passes are rotated with respect to one another by an angle α, in particular where 30°≤α≤150°.

6. The method as claimed in claim 3, wherein the welding path is chosen, and the laser beam is moved along the welding path, such that a preheating from a respective previous welding pass has subsided to such an extent that a maximum welding-in depth MT into the second workpiece in a subsequent welding pass is at most 10% greater than in the respective previous welding pass.

7. The method as claimed in claim 1, wherein the welding path comprises a multiplicity of adjacently lying welding path portions that lie adjacent to one another in a direction transverse to a local direction of extent of the welding path.

8. The method as claimed in claim 7, wherein the adjacently lying welding path portions, in particular their spacing AB in the direction transverse to the local direction of extent, are chosen such that welded partial surface regions that occur along the respective adjacently lying welding path portions directly adjoin or overlap one another.

9. The method as claimed in claim 7, wherein the adjacently lying welding path portions, in particular their spacing AB in the direction transverse to the local direction of extent, are chosen such that welded partial surface regions that occur along the respective adjacently lying welding path portions remain separated by unwelded intermediate regions.

10. The method as claimed in claim 7, wherein, after welding one welding path portion, a further welding path portion that is further away is welded before a welding path portion alongside is welded.

11. The method as claimed in claim 1, wherein the surface region is formed as a welding point.

12. The method as claimed in claim 1, wherein the surface region is formed as circular-annular.

13. The method as claimed in claim 1, wherein the welding path is at least partially in the form of an Archimedes spiral.

14. The method as claimed in claim 1, wherein the welding path comprises at least one concentric, circular welding path portion.

15. The method as claimed in claim 1, wherein the welding path comprises at least two straight-extending welding path portions lying parallel to one another.

16. The method as claimed in claim 1, wherein the welding of the first and second workpieces is performed as welding in, wherein the second workpiece is only melted as far as a maximum welding-in depth MT,
where MT≤0.5*D2,
with D2: the thickness of the second workpiece.

17. The method as claimed in claim 1, wherein
the laser beam is generated by a cw laser,
and/or in that the laser beam has a wavelength λ in an infrared spectral range, where 1000 nm≤λ≤1100 nm.

18. The method as claimed in claim 1, wherein
the first workpiece has a thickness D1 where 0.2 mm≤D1≤0.4 mm,
the second workpiece has a thickness D2 where 0.2 mm≤D2≤0.4 mm,
the laser beam has a power output P where 300 W≤P≤800 W,
the laser beam has a spot diameter SD on the surface of the first workpiece where 25 μm≤SD≤65 μm,
and the laser beam has a relative feed rate V to the workpieces, where 400 mm/s≤V≤1000 mm/s.

19. The method as claimed in claim 1, wherein the laser beam has a focus position that is defocused with respect to the surface of the first workpiece, with a defocusing DF where 0.3 mm≤DF≤0.7 mm or −0.3 mm≤DF≤−0.7 mm.

20. The method as claimed in claim 1, wherein welding is performed under an argon atmosphere.

21. The method as claimed in claim 1, further comprising producing electrical contacts on battery cells.
